(19) United States
(12) Patent Application Publication
(10) Pub. No.: US 2002/0086570 A1
(43) Pub. Date: Jul. 4, 2002

(54) METHODS AND APPARATUS FOR CONNECTING WIRES Methods and apparatus for connecting wires

(76) Inventors: Michael E. Lawrence, Fort Wayne, IN (US); Michael L. Stockman, Fort Wayne, IN (US)

Correspondence Address: John S. Beulick, Armstrong Teasdale LLP, One Metropolitan Sq., Suite 2600, St. Louis, MO, 63102, US

(21) Appl. No.: 09/751,077

(22) Filed: Dec. 29, 2000

(51) Int. Cl. H01R 13/44

(52) U.S. Cl. 439/148

(57) ABSTRACT

A terminal connector that protects a plurality of electrical lead terminals during the assembly and transportation stages of a motor assembly and provides an electrical connection for test equipment for testing the motor assembly is described. The terminal connector includes a plurality of electrical contacts extending from a top side of the connector, a plurality of second electrical contacts extending from a bottom side of the connector, and an opening extending through the connector. The plurality of second electrical contacts extend from a cavity that extends into the connector from the bottom side of the connector.

### BACKGROUND OF THE INVENTION

This invention relates generally to terminal connectors and, more particularly, to methods and apparatus for connecting wires.

Complex motor assemblies include a plurality of electrically coupled components that include a plurality of electrical lead terminals. During a plurality of manufacturing processes, the electrical lead terminals extending from the various components may become inadvertently damaged as the various components and electrical lead terminals are positioned for coupling within the motor assembly. Additionally, the terminals may be damaged during a test procedure. Furthermore, during fabrication of a motor assembly, electrical lead terminals may become contaminated with foreign substances or varnishes. The terminals can also be damaged as the motor assembly is transferred from one location on an assembly line to another location on that assembly line, as well as during shipment to a customer and or during storage at an assembly plant and at the customer's facility.

To prevent electrical lead terminals from inadvertent damage during assembly, manufacturing, transportation, storage, and inspection, electrical lead terminals are often coupled to terminal connectors. The terminal connectors encase the electrical lead terminals to prevent the electrical lead terminals from being inadvertently contacted. After delivery, the electrical lead terminals are then electrically coupled to their intended components. If the motor assembly or one of the assembly components needs testing, the electrical lead terminals are uncoupled and the test equipment is then electrically connected. Because of the complexity of wires extending within the motor assembly, coupling test equipment to the motor assembly may be a time consuming and laborious process.

### BRIEF SUMMARY OF THE INVENTION

In an exemplary embodiment, a terminal connector protects a plurality of electrical lead terminals during the assembly, transportation, and storage stages of a motor fabrication process and during the customer's assembly, testing, and storage process. Additionally, the terminal connector provides an electrical connection for test equipment to electrically couple to the motor assembly for testing the motor assembly during fabrication and during the customer's final assembly. The terminal connector includes a plurality of electrical contacts extending from a top side of the connector, a plurality of second electrical contacts extending from a bottom side of the connector, and an opening extending through the terminal connector. The plurality of second electrical contacts extend from a cavity that extends into the connector from the bottom side of the connector.

In use, the terminal connector couples to electrical lead terminals extending from a terminal to prevent damage to the terminal electrical lead terminals during assembly of the motor assembly. Because the second electrical contacts extend from the connector and are within the cavity, inadvertent contamination of the second electrical contacts is reduced. Furthermore, the second electrical contacts provide an electrical connection for test equipment to be coupled to the motor assembly thereby protecting a plurality of stator windings of the motor assembly. As a result, a terminal connector is provided which facilitates reducing damage to electrical lead terminals in a cost-effective and reliable manner.

### BRIEF DESCRIPTION OF THE DRAWINGS

FIG. 1 is a side perspective view of a terminal connector;

FIG. 2 is a bottom perspective view of the terminal connector shown in FIG. 1; and

FIG. 3 perspective view of a motor assembly including the terminal connector shown in FIG. 1.

### DETAILED DESCRIPTION OF THE INVENTION

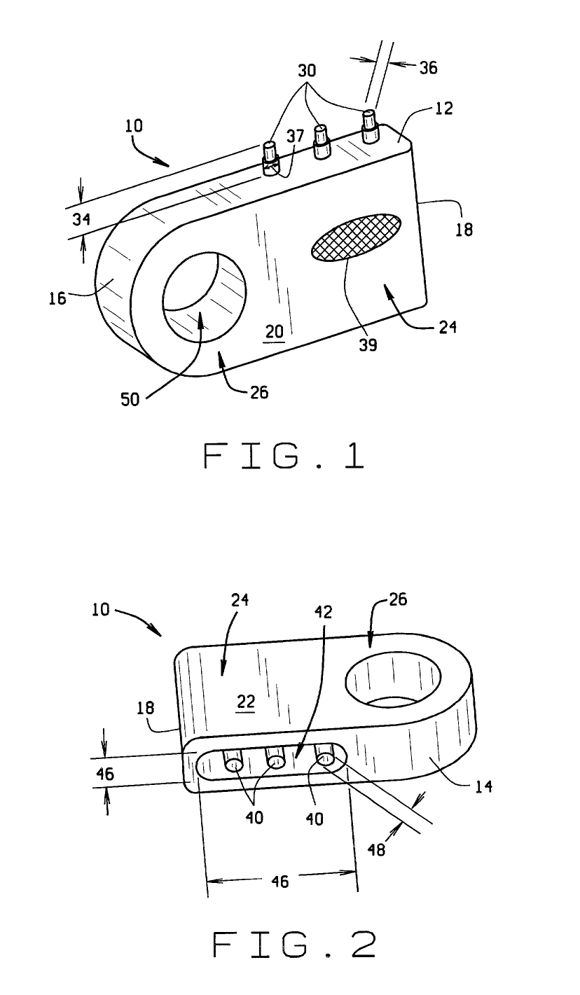

FIGS. 1 and 2 are a side perspective view and a bottom perspective view, respectively, of a terminal connector 10. Terminal connector 10 is unitarily constructed and includes a top side 12 and a bottom side 14 connected with a first side 16, a second side 18, a front side 20, and a back side 22. Front side 20 is substantially parallel with back side 22, and is a mirror image of back side 22.

Terminal connector 10 also includes a first body portion 24 and a second body portion 26. Terminal connector second body portion 26 extends between first body portion 24 and terminal connector first side 16. Terminal connector first body portion extends between second body portion 26 and terminal connector second side 18.

Terminal connector top side 12 includes a plurality of first electrical contacts 30 extending radially outward from top side 12. More specifically, first electrical contacts 30 extend substantially perpendicularly from terminal connector top side 12 within terminal connector first body portion 24 and each contact 30 is substantially rounded to facilitate connection with an electrical terminal lead. In an exemplary embodiment, each contact is rounded to provide an approximate 0.03 inch radius and all edges of terminal connector 10 are chamfered. In an alternative embodiment at least one edge of terminal connector is not chamfered. In one embodiment, electrical contacts 30 are electrical pins and are fabricated from a noncorrosive conductive material. In the exemplary embodiment, terminal connector 10 includes three electrical contacts 30. In one embodiment, contacts 30 are fabricated from stainless steel.

In one embodiment, electrical contacts 30 are each identical and extend a length 34 outward from terminal connector 10. In another embodiment, electrical contacts are each different length to provide a proper fit to different types of terminals. It is contemplated the benefits of terminal connector 10 accrue to terminal connectors for use with a plurality of lead types and each electrical contact 30 can be any length appropriate for each specific type of lead. In one embodiment, electrical contacts 30 are stepped and length 34 is a length of a shortest electrical contact. In the exemplary embodiment, each electrical contact 30 has a substantially circular cross-sectional profile and is stepped such that an end distal to terminal connector 10 has a smaller diameter than an end proximate to terminal connector 10. In one embodiment, the difference between the diameter of the distil end and the diameter of the proximate end is approximately 0.005 inch. In an alternative embodiment the differences are less than and greater than approximately 0.005 inch and contact 30 is chamfered at the step. More specifically, in an exemplary embodiment, each contact 30 has a first diameter 36 and a second diameter 37. Diameters 36 and 37 and length 34 are selected during fabrication of terminal connector 10 based on electrical requirements of a terminal (not shown) to be coupled to terminal connector 10. In an exemplary embodiment, first diameter 36 is approximately 0.083 inch and second diameter is approximately 0.088 inch.

Terminal connector bottom side 14 includes a plurality of second electrical contacts 40 and a cavity 42. Cavity 42 extends into terminal connector 10 within terminal connector first body portion 24, from terminal connector bottom side 14 towards terminal connector top side 12. More specifically, cavity 42 extends inward for a depth (not shown) and has a length 44 and a width 46. Cavity length 44 and width 46 are selected during fabrication of terminal connector 10 based on dimensions of a terminal plug (not shown) to be inserted within cavity 42.

Second electrical contacts 40 extend radially outward from terminal connector cavity 42. More specifically, electrical contacts 40 extend substantially perpendicularly from terminal connector 10 within cavity 42. In one embodiment, electrical contacts 40 are electrical pins and are fabricated from a non-corrosive conductive material. In the exemplary embodiment, terminal connector 10 includes three electrical contacts 40. In one embodiment, contacts 40 are fabricated from stainless steel.

Electrical contacts 40 are each identical and extend a length (not shown) outward from a base (not shown) of terminal connector cavity 42. In the exemplary embodiment, each electrical contact 40 has a substantially circular cross-sectional profile. More specifically, in the exemplary embodiment, each contact 40 has a diameter 48. The length and diameter 48 of electrical contacts 40 are selected during fabrication of terminal connector 10 based on electrical requirements of the terminal plug to be coupled to terminal connector 10 within cavity 42. More specifically, the length of electrical contacts 40 within terminal connector cavity 42 is less than the depth of cavity 42. Accordingly, electrical contacts 40 do not extend outward beyond terminal connector bottom side 14. In one embodiment, electrical contacts 40 are identical to electrical contacts 30 and each is aligned co-axially with each electrical contact 30. In another embodiment, electrical contacts 30 are rods that extend through terminal connector 10 from terminal connector top side 12 to terminal connector bottom side 14 to form electrical contacts 40.

Terminal connector 10 is fabricated from a non-conductive material and also includes an opening 50. In one embodiment, terminal connector 10 is molded to include opening 50. Opening 50 is substantially circular and extends through terminal connector 10 within terminal connector second body portion 26. More specifically, opening 50 extends between terminal connector front side 20 and terminal back side 22 and, in one embodiment, is chamfered at front side 20 and back side 22. Opening 50 allows for a consistent positioning of terminal connector 10 which decreases fabrication and testing time due to any searching for the terminals. In an exemplary embodiment, terminal connector 10 includes marking or indications of which terminal lead attaches to a specific contact 30. In an alternative exemplary embodiment, contacts 40 are positioned such within cavity 42 that a test connector (not shown) can be inserted into cavity only one way. In an alternative embodiment, cavity 42 includes an interior step such that the test connector can only be inserted in single way. Terminal connector 10 further includes a depressed or recessed section 39. In an exemplary embodiment, recessed section includes a knurled surface to facilitate holding connector 10 during coupling and uncoupling operations. In another embodiment, terminal connector 10 includes a second recessed section (not shown) on second side 22. The second recessed section includes a knurled surface and is oval shaped like recessed section 39.

Terminal connector first side 16 extends between terminal connector top and bottom sides 12 and 14, respectively. More specifically, terminal connector first side 16 curves between top and bottom sides 12 and 14, respectively. Terminal connector second side 18 extends substantially perpendicularly between terminal connector top and bottom sides 12 and 14.

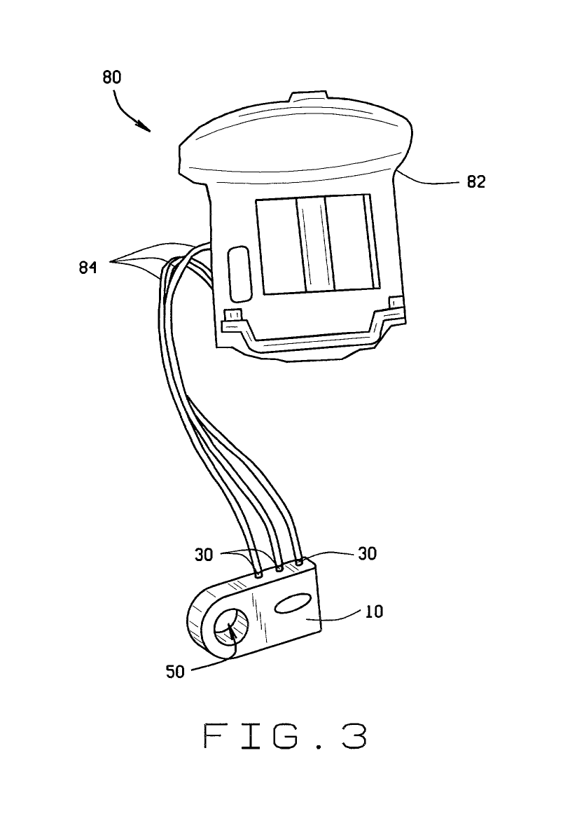

FIG. 3 is a perspective view of a motor assembly 80 electrically coupled to terminal connector 10. Motor assembly 80 includes a stator assembly 82 and a plurality of electrical lead terminals 84 extending from motor assembly 80. Each electrical lead 84 is coupled to a respective terminal connector electrical connector 30.

In use, motor assembly 80 is electrically coupled to terminal connector 10. More specifically, each motor assembly electrical lead 84 is connected to a respective terminal connector electrical connector 30. Terminal connector 10 is then electrically coupled to a terminal (not shown) to protect terminal electrical lead terminals (not shown) from damage during build-up and delivery stages of motor assembly 80. More specifically, the terminal is coupled to terminal connector electrical contacts 40 (shown in FIG. 2) within terminal connector cavity 42 (shown in FIG. 2).

Additionally, during assembly of motor assembly 80, terminal connector opening 50 provides a means to position motor terminals 84 during a varnish stage of motor stator assembly 82 to prevent motor terminals 84 from being inadvertently damaged.

After the terminal is uncoupled from terminal connector 10, electrical contacts 40 provide an electrical connection for test equipment to be coupled to motor assembly 80 for testing of motor assembly 10. Because electrical contacts 40 extend within terminal connector cavity 42, a reduction in electrical contacts 40 being contaminated by foreign substances (not shown) is facilitated.

The above-described terminal connector is cost-effective and highly reliable. The terminal connector includes a plurality of electrical contacts extending from the top side of the connector, and a plurality of second electrical contacts extending from the bottom side of the connector. The terminal connector couples to a terminal to prevent damage to the terminal during assembly of the motor assembly. Because the second electrical contacts extend from the connector within a cavity, contamination of the second electrical contacts is reduced. Furthermore, the second electrical contacts provide an access for test equipment to be coupled to the motor assembly. As a result of the terminal connector, a reduction in damage to electrical lead terminals is facilitated in a cost-effective and reliable manner.

While the invention has been described in terms of various specific embodiments, those skilled in the art will recognize that the invention can be practiced with modification within the spirit and scope of the claims.

What is claimed is:

1. A method for electrically terminating a plurality of wires using a terminal connector, the terminal connector including a top side and a bottom side connected with a first sidewall, a second sidewall, a front sidewall, and a rear sidewall, said method comprising the steps of:
electrically coupling a first wire to a first electrical pin extending radially outward from at least one of the terminal connector first side and the terminal connector second side, and
electrically coupling a second wire to a second electrical pin extending radially outward from at least one of the terminal connector first side and the terminal connector second side.

2. A method in accordance with claim 1 wherein at least one of the terminal connector top and bottom sides includes a cavity extending into the terminal connector, said method further comprising the step of electrically coupling at least one wire to an electrical pin extending from the cavity.

3. A method in accordance with claim 2 wherein said step of electrically coupling at least one wire further comprises the step of electrically coupling at least three wires to at least three pins extending from the cavity.

4. A method in accordance with claim 1 wherein said step of electrically coupling a first wire further comprises the step of electrically coupling a first wire to at least one of three pins extending from at least one of the terminal connector first side and the terminal connector second side.

5. A method in accordance with claim 1 wherein said step of electrically coupling a first wire further comprises the step of electrically coupling a first wire to at least one of three pins extending from a cavity, wherein the cavity extends into at least one of the terminal connector top and bottom sides.

6. Apparatus for terminating a plurality of electrical connections, said apparatus comprising a body comprising a top side and a bottom side connected with a first sidewall, a second sidewall, a front side, and a rear side, at least one of said top side and said bottom side comprising a cavity extending into said apparatus body, said body further comprising at least one opening extending therethrough.

7. Apparatus in accordance with claim 6 wherein at least one of said top side and said bottom side comprising a plurality of electrical pins extending radially outward from said apparatus body.

8. Apparatus in accordance with claim 6 wherein said body opening extends from said front sidewall to said rear sidewall.

9. Apparatus in accordance with claim 6 wherein said body further comprises a plurality of electrical pins extending radially outward from said body cavity.

10. Apparatus in accordance with claim 6 wherein said apparatus top side comprises a plurality of first pins extending radially outward, said apparatus body bottom sides comprises a plurality of second pins extending radially outward from said cavity.

11. Apparatus in accordance with claim 10 wherein said top side comprises three pins extending radially outward.

12. Apparatus in accordance with claim 10 wherein said bottom side comprises three pins extending radially outward.

13. Apparatus in accordance with claim 10 wherein said plurality of second pins do not extend beyond said cavity.

14. A terminal connector for terminating a plurality of electrical connections, said connector comprising a top side and a bottom side connected with a first sidewall, a second sidewall, a front side, and a rear side, at least one of said top side and said bottom side comprising a cavity extending into said terminal connector, said connector further comprising a plurality of first pins extending radially outward from said cavity.

15. A terminal connector in accordance with claim 14 wherein said terminal connector further comprises at least one opening extending therethrough.

16. A terminal connector in accordance with claim 15 wherein said terminal connector opening extends between said front sidewall and said rear sidewall.

17. A terminal connector in accordance with claim 14 further comprising a plurality of second pins extending radially outward from at least one of said top side and said bottom side opposite said plurality of first pins.

18. A terminal connector in accordance with claim 17 wherein top side comprises three pins extending radially outward.

19. A terminal connector in accordance with claim 17 wherein said bottom side comprises three pins extending radially outward.

20. A terminal connector in accordance with claim 17 wherein said opening configured as a holdback device during a varnish process.
